(19) United States
(12) Patent Application Publication
(10) Pub. No.: US 2010/0082974 A1
(43) Pub. Date: Apr. 1, 2010

(54) PARALLEL DOCUMENT PROCESSING

(75) Inventors: Sarjana Sheth, Redmond, WA (US); Justin Slone, Seattle, WA (US); Jack Davis, Woodinville, WA (US); Ruke Huang, Redmond, WA (US); Patrick T. O'Brien, JR., Kirkland, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/238,767

(22) Filed: Sep. 26, 2008

(51) Int. Cl. H04L 9/32; H04L 9/08; H04L 9/30

(52) U.S. Cl. 713/156; 713/176; 380/278

(57) ABSTRACT

Documents distributed in parallel are processed. One or more digital document packages are received, where each digital document package includes a content portion and an identity-verification code (IVC) verifying an identity of a source from which the digital document package is received. Each IVC may be a private-key encryption of a content-verification code hashed from the content portion of each digital document package. A master digital document package is created, which includes a master content portion equivalent to the content portion in each unmodified digital document package, and one or more different IVCs, each IVC obtained from a digital document package received from a different source.

### BACKGROUND

A common way to distribute a document to various sources is by means of an electronic form of the document. Several methods exist for an original source to distribute such a digital document to other users, such as by email with the digital document as an attachment, by providing a link from which the user may download the digital document, or by saving the digital document to a network that the user may access. Upon receiving and reviewing the digital document, the user may sign the digital document and return the digital document to the original source.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

Various embodiments related to parallel document processing are disclosed herein. One disclosed embodiment includes a method of processing documents distributed in parallel. First, one or more digital document packages are received, where each digital document package includes a content portion and an identity-verification code (IVC) verifying an identity of a source from which the digital document package is received. Each IVC may be a private-key encryption of a content-verification code hashed from the content portion of each digital document package. Next, a master digital document package is created, which includes a master content portion equivalent to the content portion in each unmodified digital document package, and one or more different IVCs, each IVC obtained from a digital document package received from a different source.

### BRIEF DESCRIPTION OF THE DRAWINGS

FIG. 1 shows a process flow of an example method of processing documents distributed in parallel.

FIG. 2 shows a process flow for creating an IVC in accordance with an embodiment of the present disclosure.

FIG. 3 shows another process flow for creating an IVC in accordance with an embodiment of the present disclosure.

FIG. 4 shows a process flow of an example method of processing documents distributed in parallel.

FIG. 5 shows a process flow of an example method for verifying IVCs packaged with documents distributed in parallel.

### DETAILED DESCRIPTION

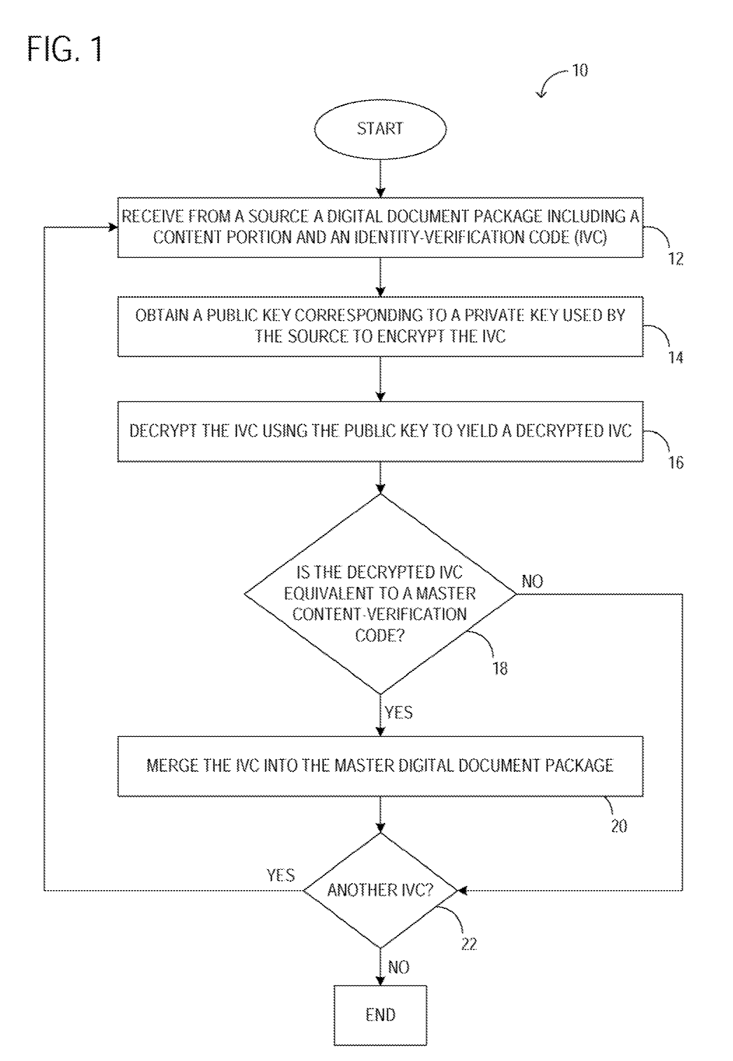

FIG. 1 shows a process flow of an example method 10 of processing documents distributed in parallel. At 12, method 10 includes receiving from a source a digital document package including a content portion and an identity-verification code (IVC). The IVC verifies the identity of the source from which the digital document package is received and may indicate an affirmative acceptance of the contents of the document package by the source. The IVC may be a private-key encryption of a content-verification code hashed from the content portion of the digital document package.

As discussed above, the content-verification code results from applying a hash function to the digital document package. The hash function receives as input the digital document package, or at least a content portion thereof, and outputs a string, namely the content-verification code. Such a content-verification code has a unique correspondence to the digital document package in that equivalent digital document packages will yield the same content-verification code, whereas different digital document packages will yield different content-verification codes. Furthermore, although it may be straightforward to generate the content-verification code from the digital document package, the reverse approach of constructing a digital document package from a content-verification code should be nearly impossible in practice.

Upon encryption with a private key, the content-verification code becomes an IVC. Such an encryption follows a public-key cryptography methodology, where a key used to encrypt a message differs from a key used to decrypt the encrypted message. In public-key cryptography, a user is assigned a pair of cryptographic keys, namely a public key and a private key. The private key is kept secret, while the public key may be widely distributed by any suitable means. The keys are related mathematically, but the private key may not be practically derived from the public key.

The IVC may be added to a digital document package according to a predetermined set of processing rules and syntax for creating and adding the IVC to the digital document package. Furthermore, the IVC may be added to a digital document package via an application utilizing such processing rules and syntax. As described in more detail below, the same or different applications may use the same processing rules and syntax for aggregating two or more IVCs into a master document.

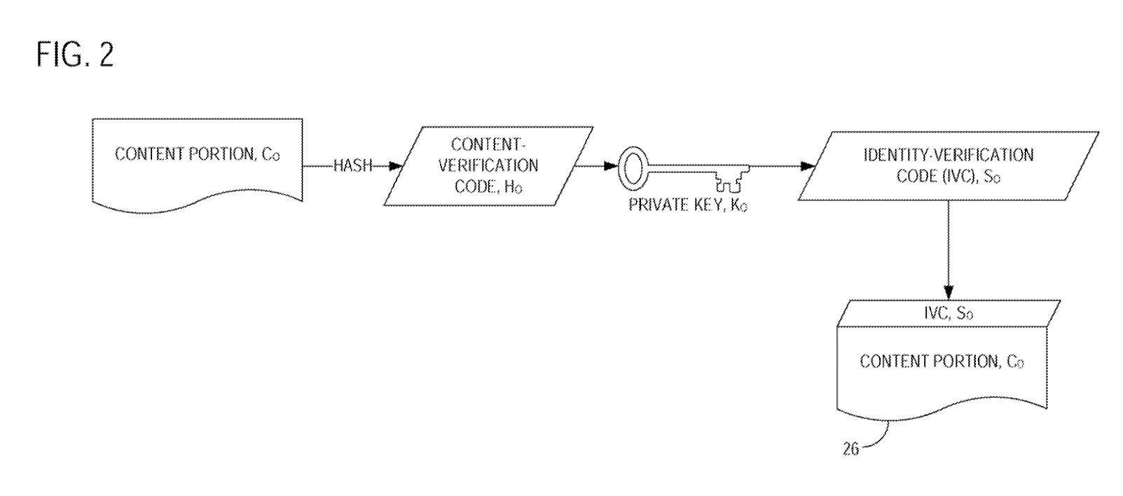

FIG. 2 shows a process flow for creating an IVC in accordance with an embodiment of method 10. Such an approach comprises adding an IVC to a content portion to yield a digital document package. FIG. 2 begins with a content portion C_{O}, being hashed to yield a content-verification code H_{O}. The content-verification code H_{O} may then be encrypted with a private key K_{O}. This yields an IVC S_{O}, corresponding to the owner of the private key K_{O}. Lastly, the IVC S_{O} is packaged with the content portion C_{O} to form a digital document package 26.

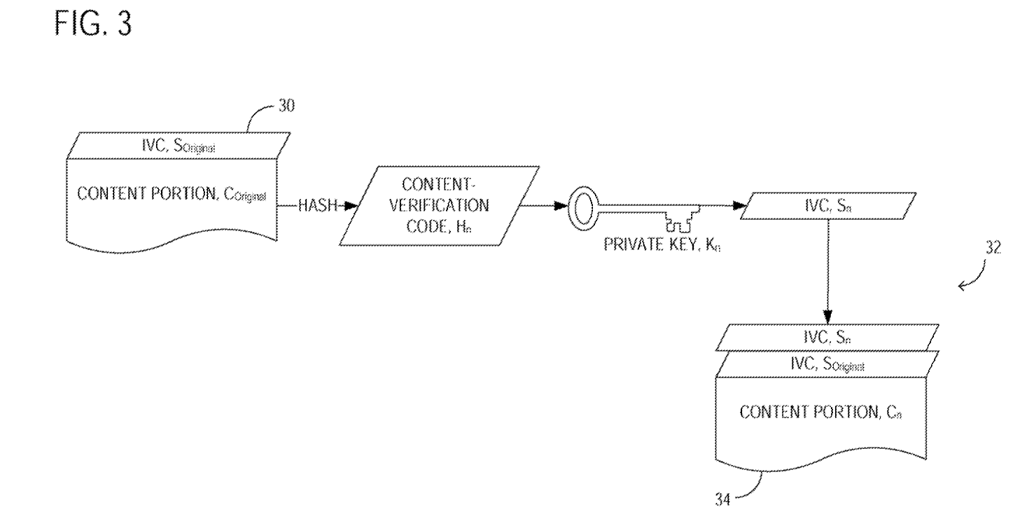

FIG. 3 shows another process flow for creating an IVC in accordance with an embodiment of method 10. Such an approach comprises adding an IVC that may be a private-key encryption of a digital document package, and therefore such an IVC may be a private-key encryption of both a content-verification code and another IVC. FIG. 3 begins with an original digital document package 30 being hashed to yield a content-verification code Hₙ. The content-verification code Hₙ may then be encrypted with a private key Kₙ. This yields an IVC Sₙ, corresponding to the owner of the private key Kₙ. Lastly, at 32, the IVC Sₙ may be added to the original digital document package 30 yielding a digital document package 34.

Returning to FIG. 1, method 10 next includes, at 14, obtaining a public key corresponding to a private key used by the source to encrypt the IVC. The public key may be obtained by any suitable method. One suitable method includes obtaining the public key via a digital certificate corresponding to the source of the IVC, where the digital certificate provides access to the public key.

The digital certificate may be issued by a trusted certification authority, where the trusted certification authority guarantees the validity of the digital certificate and guarantees that the public key accessible via the digital certificate corresponds to the source of the digital certificate. Furthermore, the digital certificate includes a certification authority identity-verification code corresponding to the trusted certification authority. Anyone who obtains the digital certificate may then examine the digital certificate to confirm that it was issued by a trusted certification authority.

At 16, method 10 includes decrypting the IVC using the public key to yield a decrypted IVC. At 18, method 10 includes comparing the decrypted IVC to a master content-verification code. The master content-verification code may be calculated by hashing a master content portion of a master digital document package. The master digital document package being a digital document package into which the IVCs may be merged at a later step. The master content portion is equivalent to an original content portion of an original digital document package sent to the source.

The purpose of this step is to determine if the source modified the content portion of the digital document package when adding their IVC. If the source did not change the content portion of the digital document package when adding their IVC, decrypting this IVC at 16 yields a decrypted IVC equivalent to the master content-verification code, in which case method 10 further includes, at 20, merging the IVC into the master digital document package.

Merging the IVC into the master digital document package may comprise updating a table of contents of the master digital document package, the table of contents indexing each of the IVCs of the master digital document package.

Next, at 22 method 10 comprises determining if there are any other IVCs that are to be added to the master digital document package. If so, method 10 loops to 12 to start method 10 again. If there are no more IVCs to add to the master digital document package at 22, then method 10 ends.

If method 10 at 18 instead determines that the decrypted IVC is not equivalent to the master content-verification code, then the IVC may be rejected and not merged into the master digital document package. In this case, method 10 bypasses 20 and continues to 22 described above.

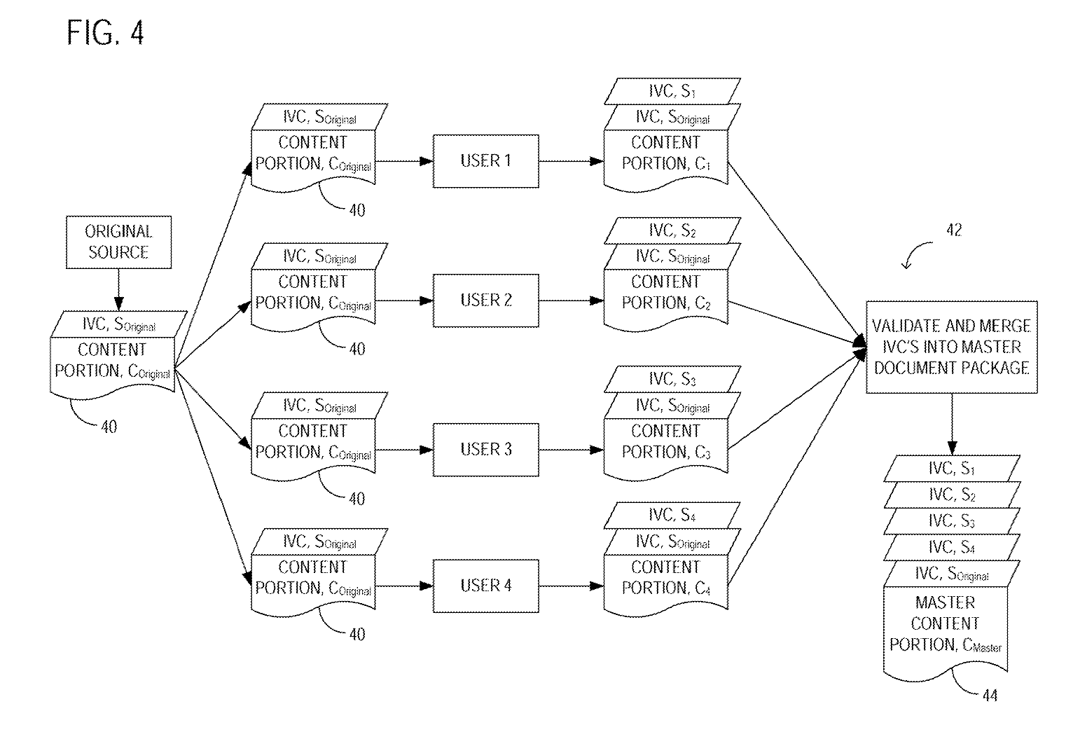

FIG. 4 shows a process flow of an example method of processing documents distributed in parallel. FIG. 4 begins with an original source adding their IVC S_{Original}, to an original content portion C_{Original}, to yield a digital document package 40. The original source then sends the digital document package 40 in parallel to a plurality of users. Each user adds their IVC to digital document package 40 received from the source.

In some embodiments, the digital document package 40 may be sent to the users according to a signing policy. Such a signing policy may indicate restrictions on who may add an IVC to the digital document package, so that the digital document package cannot be forwarded to unintended participants who could then add an unwanted IVC.

At 42, upon receiving and validating that a content portion received from each user is equivalent to the original content portion C_{Original}, now re-named the master content portion C_{Master}, the IVCs may be merged into the master digital document package, yielding a master digital document package 44. As such, each merged IVC may independently verify an identity of the source from which that digital document package is received.

In other embodiments, upon receiving a content portion from each user, the IVCs may be merged into the master digital document package without validating the IVCs prior to merging. This yields a master digital document package including a master content portion equivalent to the content portion in each unmodified digital document package, and a plurality of different IVCs, each identity-verification code obtained from a digital document package received from a different source. In such embodiments, an IVC corresponding to each unmodified digital document package is valid whereas an IVC corresponding to a modified digital document package is invalid.

Thus, the master digital document package 44 includes a master content portion C_{Master}, equivalent to the original content portion C_{Original}, and a plurality of different IVCs, each IVC obtained from a digital document package received in parallel from a different user.

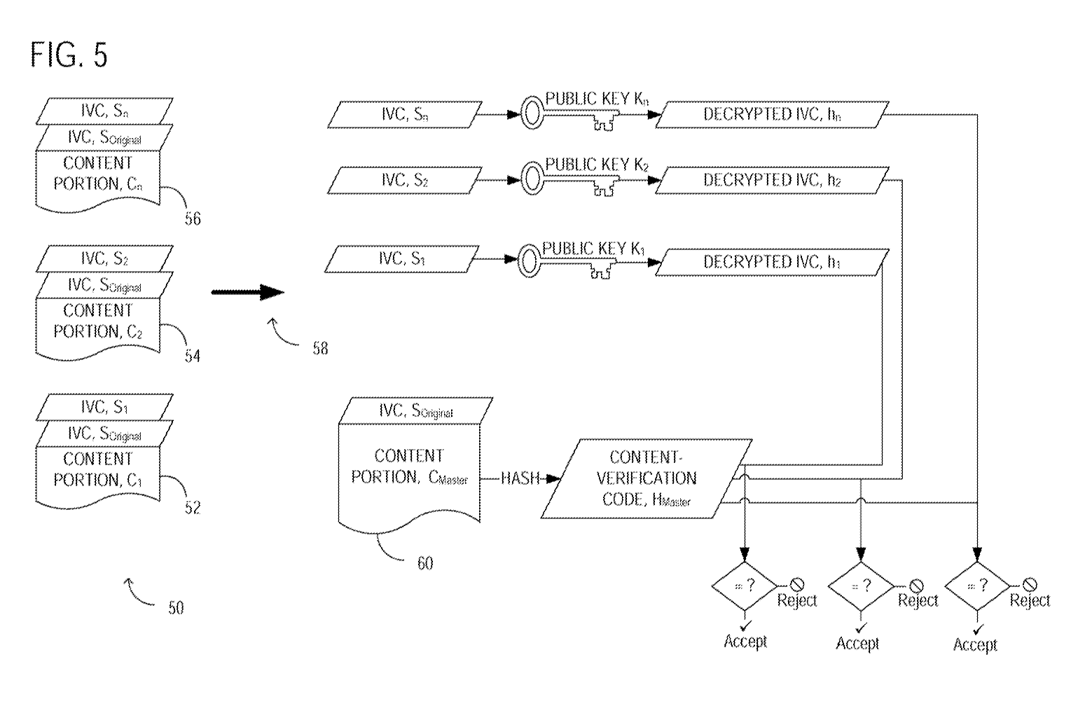

FIG. 5 shows a process flow of an example method for verifying IVCs packaged with documents distributed in parallel. FIG. 5 begins at 50 with receiving a plurality of digital document packages. Each digital document package (e.g., digital document package 52, digital document package 54, and digital document package 56) has had an IVC added, where the IVC corresponds to different users. Next, at 58, the digital document packages are examined to determine if the IVCs (e.g., S₁, S₂ and Sₙ) may be added to a master digital document package 60.

Upon receiving the digital document packages at 58, each IVC may be decrypted with the public key corresponding to that user. For example, IVC Sₙ may be decrypted with public key Kₙ corresponding to user n. Each decrypted IVC (e.g., h₁, h₂ and hₙ) may then be compared to the content-verification code H_{Master}, hashed from the master content portion C_{Master}. If a decrypted IVC (e.g., h₁, h₂ and/or hₙ) is determined to be equivalent to the content-verification code H_{Master}, then the decrypted IVC (e.g., h₁, h₂ and/or hₙ) may be accepted and the corresponding IVC (e.g., S₁, S₂ and/or Sₙ) may be merged into the master digital document package. If a decrypted IVC (e.g., h₁, h₂ and/or hₙ) is determined to be different than the content-verification code H_{Master}, then the decrypted IVC (e.g., h₁, h₂ and/or hₙ) may be rejected and the corresponding IVC (e.g., S₁, S₂ and/or Sₙ) may be left out of the master digital document package. In this way, it can be ensured that the master document will only include IVCs from individuals that did not change the content of the original document. In other words, all IVCs packaged in the master document are based on the same content.

It should be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A method of processing documents distributed in parallel, the method comprising:
receiving a plurality of digital document packages, each digital document package including a content portion and an identity-verification code verifying an identity of a source from which the digital document package is received, the identity-verification code being a private-key encryption of a content-verification code hashed from the content portion of the digital document package; and
creating a master digital document package including a master content portion equivalent to the content portion in each unmodified digital document package, and a plurality of different identity-verification codes, each identity-verification code obtained from a digital document package received from a different source.

2. The method of claim 1, where creating the master digital document package comprises calculating a master content-verification code hashed from the master content portion, and for each of the plurality of different identity-verification codes of the master digital document package:
obtaining a public key corresponding to a private key used to encrypt that identity-verification code;
decrypting that identity-verification code using the public key to yield a decrypted identity-verification code;
comparing that decrypted identity-verification code to the master content-verification code; and
merging that identity-verification code into the master digital document package only if that decrypted identity-verification code is equivalent to the master content-verification code.

3. The method of claim 2, where obtaining a public key corresponding to a private key used to encrypt that identity-verification code includes obtaining a digital certificate corresponding to the source of that identity-verification code, the digital certificate providing access to the public key.

4. The method of claim 3, where the digital certificate is issued by a trusted certification authority, the trusted certification authority guaranteeing the validity of the digital certificate and the trusted certification authority guaranteeing that the public key accessible via the digital certificate corresponds to the source of the digital certificate.

5. The method of claim 4, where the digital certificate includes a certification authority identity-verification code corresponding to the trusted certification authority.

6. The method of claim 2, where merging the identity-verification code into the master digital document package comprises updating a table of contents of the master digital document package, the table of contents indexing each of the identity-verification codes of the master digital document package.

7. The method of claim 1, where one or more identity-verification codes are a private-key encryption of both a content-verification code and another identity-verification code.

8. A method of processing documents distributed in parallel, the method comprising:
receiving a first digital document package, the first digital document package including a first content portion and a first identity-verification code verifying an identity of a first source from which the first digital document package is received, the first identity-verification code being a private-key encryption of a first content-verification code hashed from the first content portion of the first digital document package;
obtaining a first public key corresponding to a first private key used to encrypt the first identity-verification code;
decrypting the first identity-verification code using the first public key to yield a decrypted first identity-verification code;
comparing the decrypted first identity-verification code to a master content-verification code hashed from a master content portion of a master digital document package;
merging the first identity-verification code into the master digital document package only if the decrypted first identity-verification code is equivalent to the master content-verification code;
receiving a second digital document package, the second digital document package including a second content portion and a second identity-verification code verifying an identity of a second source from which the second digital document package is received, the second identity-verification code being a private-key encryption of a second content-verification code hashed from the second content portion of the second digital document package;
obtaining a second public key corresponding to a second private key used to encrypt the second identity-verification code;
decrypting the second identity-verification code using the second public key to yield a decrypted second identity-verification code;
comparing the decrypted second identity-verification code to the master content-verification code; and
merging the second identity-verification code into the master digital document package only if the decrypted second identity-verification code is equivalent to the master content-verification code.

9. The method of claim 8, where the master digital document package comprises an original digital document package, the original digital document package comprising an original content portion of the original digital document package and an original identity-verification code of an original source of the original digital document package, the original content portion being equivalent to the master content portion.

10. The method of claim 8, where obtaining the first public key corresponding to a first private key used to encrypt the first identity-verification code includes obtaining a first digital certificate corresponding to the first source, the first digital certificate providing access to the first public key.

11. The method of claim 10, where the first digital certificate is issued by a trusted certification authority, the trusted certification authority guaranteeing the validity of the first digital certificate and the trusted certification authority guaranteeing that the first public key accessible via the first digital certificate corresponds to the first source.

12. The method of claim 11, where the first digital certificate includes a certification authority identity-verification code corresponding to the trusted certification authority.

13. The method of claim 8, where merging the first identity-verification code into the master digital document package comprises updating a table of contents of the master digital document package, the table of contents indexing a plurality of identity-verification codes of the master digital document package.

14. A method of processing documents distributed in parallel, the method comprising:
receiving a plurality of digital document packages, each digital document package including a content portion and an identity-verification code verifying an identity of a source from which the digital document package is received, the identity-verification code being a private-key encryption of a content-verification code hashed from both the content portion of the digital document package and an original identity-verification code of the digital document package; and
creating a master digital document package including a master content portion equivalent to the content portion in each unmodified digital document package, and a plurality of different identity-verification codes, each identity-verification code obtained from a digital document package received from a different source, each identity-verification code independently verifying an identity of the source from which that digital document package is received.

15. The method of claim 14, where creating the master digital document package comprises calculating a master content-verification code hashed from both the master content portion and the original identity-verification code, and for each of the plurality of different identity-verification codes of the master digital document package:
obtaining a public key corresponding to a private key used to encrypt that identity-verification code;
decrypting that identity-verification code using the public key to yield a decrypted identity-verification code;
comparing that decrypted identity-verification code to the master content-verification code; and
merging that identity-verification code into the master digital document package only if that decrypted identity-verification code is equivalent to the master content-verification code.

16. The method of claim 15, where obtaining a public key corresponding to a private key used to encrypt that identity-verification code includes obtaining a digital certificate corresponding to the source of that identity-verification code, the digital certificate providing access to the public key.

17. The method of claim 16, where the digital certificate is issued by a trusted certification authority, the trusted certification authority guaranteeing the validity of the digital certificate and the trusted certification authority guaranteeing that the public key accessible via the digital certificate corresponds to the source of the digital certificate.

18. The method of claim 17, where the digital certificate includes a certification authority identity-verification code corresponding to the trusted certification authority.

19. The method of claim 15, where merging the identity-verification code into the master digital document package comprises updating a table of contents of the master digital document package, the table of contents indexing each of the identity-verification codes of the master digital document package.

20. The method of claim 14, where one or more identity-verification codes are a private-key encryption of both a content-verification code and another identity-verification code.
